(19) United States
(12) Patent Application Publication
(10) Pub. No.: US 2013/0342735 A1
(43) Pub. Date: Dec. 26, 2013

(54) IMAGE PROCESSING METHOD AND IMAGE PROCESSING APPARATUS FOR PERFORMING DEFOCUS OPERATION ACCORDING TO IMAGE ALIGNMENT RELATED INFORMATION

(71) Applicants: Chen-Hung Chan, Taoyuan County (TW); Chia-Ming Cheng, Hsinchu City (TW)

(72) Inventors: Chen-Hung Chan, Taoyuan County (TW); Chia-Ming Cheng, Hsinchu City (TW)

(21) Appl. No.: 13/528,829

(22) Filed: Jun. 20, 2012

(51) Int. Cl. G06K 9/32; H04N 5/217; G06K 9/40

(52) U.S. Cl. 348/241; 382/294; 382/260; 348/E05.078

(57) ABSTRACT

An image processing method includes: receiving a plurality of input images; deriving an image alignment related information from performing an image alignment upon the input images; and generating a processed image by performing a defocus operation upon a selected image selected from the input images according to the image alignment related information. For example, the image processing method may be employed by an electronic device such as a mobile device. Thus, the mobile device may capture two or more images to generate the defocus visual effect, which is similar to professional long-focus lens.

### BACKGROUND

The disclosed embodiments of the present invention relate to processing a plurality of input images to generate one or more processed images, and more particularly, to an image processing method and image processing apparatus for performing a defocus operation according to an image alignment related information.

With development of the semiconductor technology, more functions are allowed to be supported by a single electronic device. For example, a mobile device (e.g., a mobile phone) can be equipped with a digital camera. Hence, the user can use the digital camera of the mobile device for capturing an image. It is advantageous that the mobile device is capable of providing additional visual effects for the captured images. For example, blurry backgrounds are in most cases a great way to enhance the importance of the main subject and to get rid of distractions in the background. This effect is achieved in digital photography by making use of shallow depth of field. The conventional mechanical means may be employed to achieve the shallow depth of field by properly setting the aperture and the focusing distance. To simplify the shallow depth of field control, the mobile device may perform post-processing upon the captured image to create the shallow depth of field. However, the conventional post-processing scheme generally requires a complicated algorithm, which consumes much power and resource. Thus, there is a need for an innovative image processing scheme which can create the shallow depth of field for the captured images in a simple and efficient way.

### SUMMARY

In accordance with exemplary embodiments of the present invention, an image processing method and image processing apparatus for performing a defocus operation according to an image alignment related information are proposed to solve the problems mentioned above.

According to a first aspect of the present invention, an exemplary image processing method is disclosed. The exemplary image processing method includes: receiving a plurality of input images; deriving an image alignment related information from performing an image alignment upon the input images; and generating a processed image by performing a defocus operation upon a selected image selected from the input images according to the image alignment related information.

According to a second aspect of the present invention, an exemplary image processing method is disclosed. The exemplary image processing method includes: receiving a plurality of input images that are sequentially captured through a single lens of an image capture device while the image capture device is moving and/or rotating; and generating a processed image by performing a defocus operation according to the input images.

According to a third aspect of the present invention, an exemplary image processing method is disclosed. The exemplary image processing method includes: receiving a plurality of input images that are respectively captured by multiple lens of one or more image capture devices; and generating a processed image by performing a defocus operation according to the input images.

According to a fourth aspect of the present invention, an exemplary image processing apparatus is disclosed. The exemplary image processing apparatus includes a receiving unit, an image alignment unit and a defocus unit. The receiving unit is capable of receiving a plurality of input images. The image alignment unit is coupled to the receiving unit, and capable of deriving an image alignment related information from performing an image alignment upon the input images. The defocus unit is coupled to the receiving unit and the image alignment unit, and capable of generating a processed image by performing a defocus operation upon a selected image selected from the input images according to the image alignment related information.

According to a fifth aspect of the present invention, an exemplary image processing apparatus is disclosed. The exemplary image processing apparatus includes a receiving unit and an image processing block. The receiving unit is capable of receiving a plurality of input images that are sequentially captured through a single lens of an image capture device while the image capture device is moving and/or rotating. The image processing block is capable of generating a processed image by performing a defocus operation according to the input images.

According to a sixth aspect of the present invention, an exemplary image processing apparatus includes a receiving unit and an image processing block. The receiving unit is capable of receiving a plurality of input images that are respectively captured by multiple lens of one or more image capture devices. The image processing block is capable of generating a processed image by performing a defocus operation according to the input images.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating an image processing apparatus according to an exemplary embodiment of the present invention.

FIG. 2 is a diagram illustrating the generation of the input images according to a first embodiment of the present invention.

FIG. 3 is a diagram illustrating the generation of the input images according to a second embodiment of the present invention.

FIG. 4A is a diagram illustrating the generation of the input images according to a third embodiment of the present invention.

FIG. 4B is a diagram illustrating the generation of the input images according to a fourth embodiment of the present invention.

FIG. 5 is a diagram illustrating an example of one input image received by the receiving unit shown in FIG. 1.

FIG. 6 is a diagram illustrating an example of another input image received by the receiving unit shown in FIG. 1.

FIG. 7 is a diagram illustrating aligned images with foreground object alignment according to an exemplary embodiment of the present invention.

FIG. 8 is a diagram illustrating aligned images with background object alignment according to an exemplary embodiment of the present invention.

FIG. 9 is a diagram illustrating a first example of the processed image generated from the image processing apparatus shown in FIG. 1.

FIG. 10 is a diagram illustrating a second example of the processed image generated from the image processing apparatus shown in FIG. 1.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

The invention proposes using a camera of a mobile device or any other image capture device to capture two or more images to generate the defocus visual effect, which is similar to professional long-focus lens. Further details are described as below.

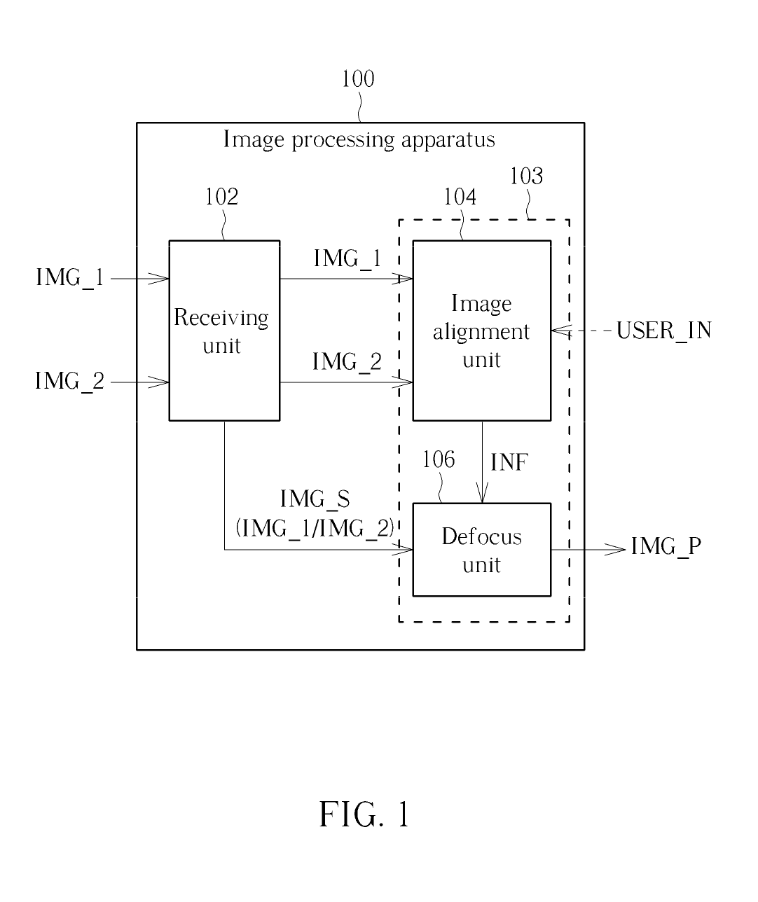

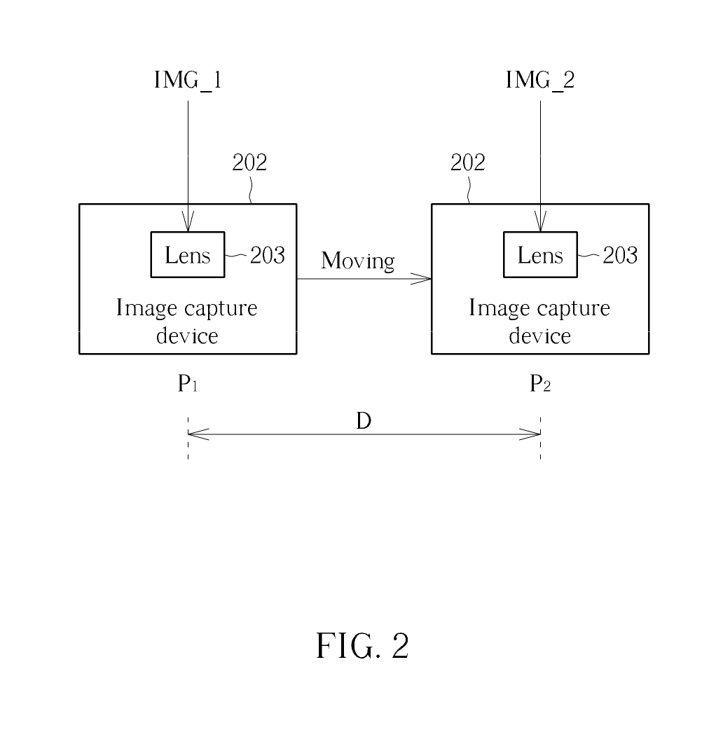

FIG. 1 is a block diagram illustrating an image processing apparatus according to an exemplary embodiment of the present invention. The image processing apparatus 100 may be employed by any electronic device which is required to provide an output image with the defocus visual effect. By way of example, but not limitation, the image processing apparatus 100 may be an image processor chip implemented in a mobile device (e.g., a mobile phone). As shown in FIG. 1, the exemplary image processing apparatus 100 can include a receiving unit 102 and an image processing block 103, where the image processing block 103 can include an image alignment unit 104 coupled to the receiving unit 102, and a defocus unit 106 coupled to the receiving unit 102 and the image alignment unit 104. The receiving unit 102 can act as an input interface for receiving a plurality of input images. In this embodiment, two input images IMG_1 and IMG_2 are received by the receiving unit 102 for further processing. It should be noted that the number of the input images is not limited to two, and may be adjusted according design requirement/consideration. The input images IMG_1 and IMG_2 do not have the same image content, and may be generated by using a single-lens camera system, a multi-lens camera system or a plurality of cameras. Please refer to FIG. 2, which is a diagram illustrating the generation of the input images IMG_1 and IMG_2 according to a first embodiment of the present invention. The image capture device (e.g., a digital camera module) 202 may be part of the mobile device in which the image processing apparatus 100 is disposed or any other device, or be a stand-alone device. As shown in FIG. 2, the image capture device 202 may have a single lens 203. When the image capture device 202 is located at a first location P₁, the user may use the image capture device 202 to capture the input image IMG_1 through the single lens 203. Next, the user may move the image capture device 202 to a new location P₂ in a rightward direction such that there is a displacement D in the moving direction, and then use the image capture device 202 to capture the other input image IMG_2 through the single lens 203. As a result, input images IMG_1 and IMG_2 with different image contents can be generated and provided to the image processing apparatus 100. Please note that the moving direction shown in FIG. 2 is for illustrative purposes only. The user is allowed to move the image capture device 202 from a current location to a new location in a leftward direction or any other direction.

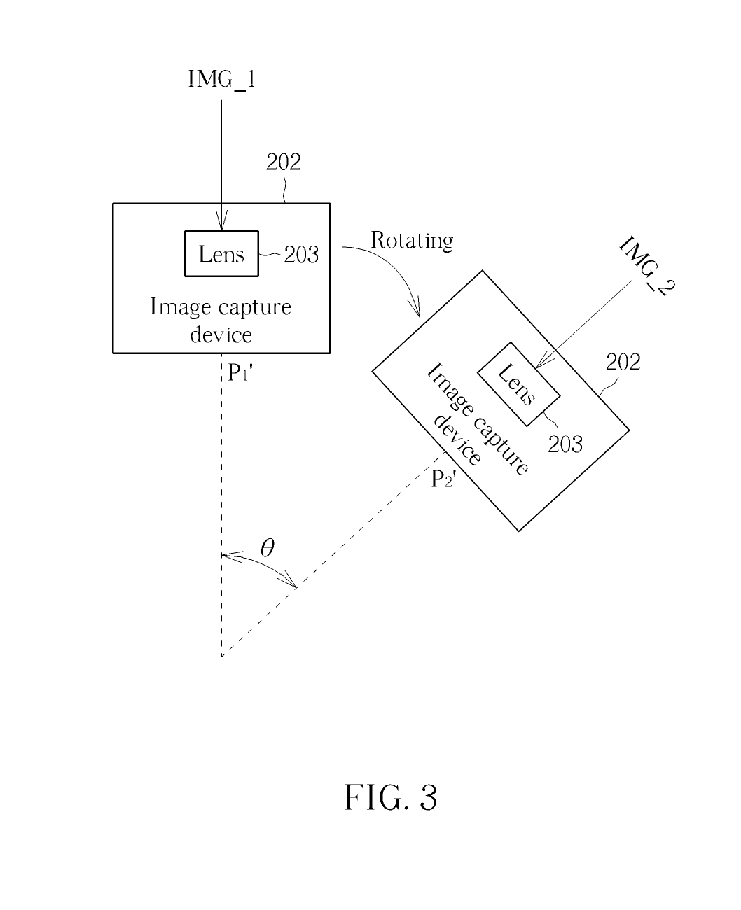

Please refer to FIG. 3, which is a diagram illustrating the generation of the input images IMG_1 and IMG_2 according to a second embodiment of the present invention. When the image capture device 202 is located at a first location P₁′, the user may use the image capture device 202 to capture the input image IMG_1 through the single lens 203. Next, the user may rotate the image capture device 202 to a new location P₂′ in a clockwise direction such that there is an included angle θ in the rotating direction, and then use the image capture device 202 to capture the input image IMG_2 through the single lens 203. As a result, input images IMG_1 and IMG_2 with different image contents can be generated and provided to the image processing apparatus 100. Please note that the rotating direction shown in FIG. 3 is for illustrative purposes only. The user is allowed to rotate the image capture device 202 from a current location to a new location in a counterclockwise direction or any other direction.

FIG. 2 shows that the location of the image capture device 202 is adjusted by simply moving the image capture device 202. FIG. 3 shows that the location of the image capture device 202 is adjusted by simply rotating the image capture device 202. However, the user may move and rotate the image capture device 202 to change the location of the image capture device 202. The same objective of sequentially obtaining input images IMG_1 and IMG_2 with different image contents is achieved.

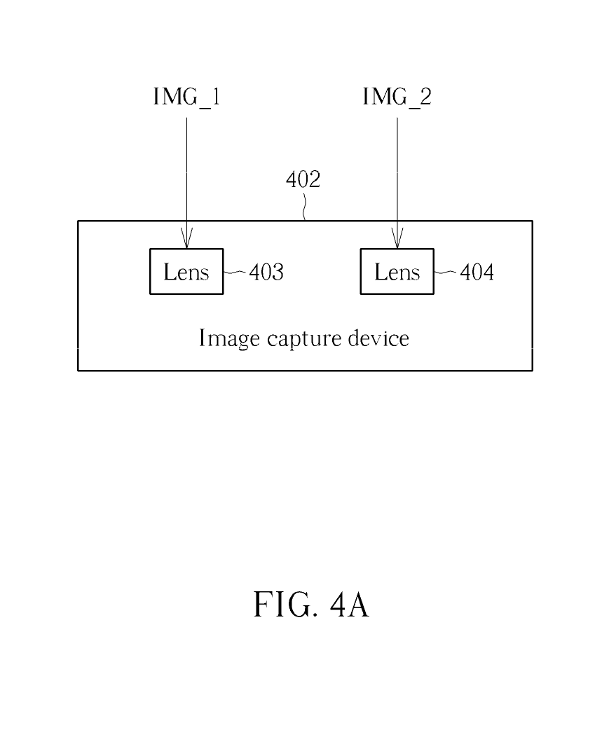

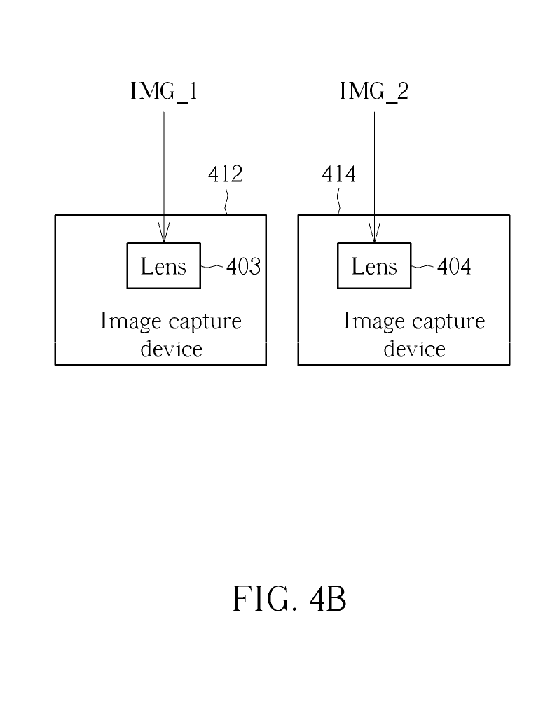

Please refer to FIG. 4A, which is a diagram illustrating the generation of the input images IMG_1 and IMG_2 according to a third embodiment of the present invention. The image capture device (e.g., a digital camera module) 402 may be disposed in the mobile device in which the image processing apparatus 100 is disposed or any other device, or be a stand-alone device. As shown in FIG. 4A, the image capture device 402 can have a plurality of lens 403 and 404. For example, the lens 403 may be used to capture a left-eye view, and the lens 404 may be used to capture a right-eye view. Hence, the user may use the image capture device 402 to capture the input image IMG_1 through the lens 403 and capture the input image IMG_2 through the lens 404. The input images IMG_1 and IMG_2 can be captured at the same time. As there is a displacement between the lens 403 and 404, input images IMG_1 and IMG_2 with different image contents can be generated and provided to the image processing apparatus 100.

Using a single multi-lens image capture device may be equivalent to using multiple image capture devices each having at least one lens. Thus, the image capture device 402 shown in FIG. 4A may be replaced by two individual image capture devices 412 and 414 shown in FIG. 4B. FIG. 4B is a diagram illustrating the generation of the input images IMG_1 and IMG_2 according to a fourth embodiment of the present invention. As can be seen from the figure, one individual image capture device 412 is equipped with the lens 403, and the other individual image capture device 414 is equipped with the lens 404. The same objective of obtaining input images IMG_1 and IMG_2 with different image contents is achieved.

As mentioned above, the input images IMG_1 and IMG_2 may be generated under the control of the user. However, the present invention has no limitation on the source of the input images IMG_1 and IMG_2. For example, the input images IMG_1 and IMG_2 with different image contents may be read from an internal/external storage device or obtained from a communication network, and then processed by the proposed image processing apparatus 100. This also falls within the scope of the present invention.

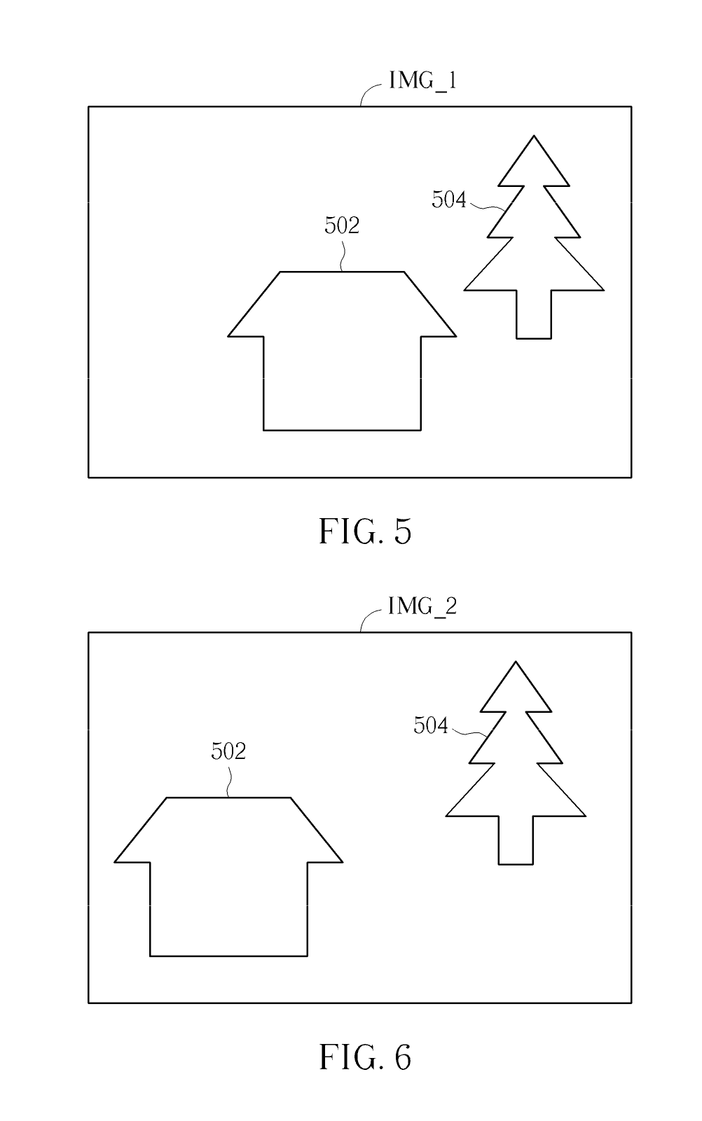

After the input images (e.g., IMG_1 and IMG_2) are received by the receiving unit 102, the image alignment unit 104 of the image processing block 103 is operative to derive an image alignment related information INF from performing an image alignment operation upon the received input images (e.g., IMG_1 and IMG_2). Specifically, the image alignment unit 104 is capable of aligning the input images IMG_1 and IMG_2 to obtain aligned images, and estimating difference between at least portions of the aligned images to generate the image alignment related information INF. For example, part of one aligned image may be compared with part of the other aligned image to obtain the image alignment related information INF. Examples of the input images IMG_1 and IMG_2 are illustrated in FIG. 5 and FIG. 6, respectively. Each of the input images IMG_1 and IMG_2 may include a foreground object 502 and a background object 504. However, due to different image capture conditions, the location of the foreground object 502 in one input image IMG_1 may be different from the location of the foreground object 502 in the other input image IMG_2, and the location of the background object 504 in one input image IMG_1 may be different from the location of the background object 504 in the other input image IMG_2. Besides, the relative locations of the foreground object 502 and the background object 504 in one input image IMG_1 may be different from the relative locations of the foreground object 502 and the background object 504 in the other input image IMG_2.

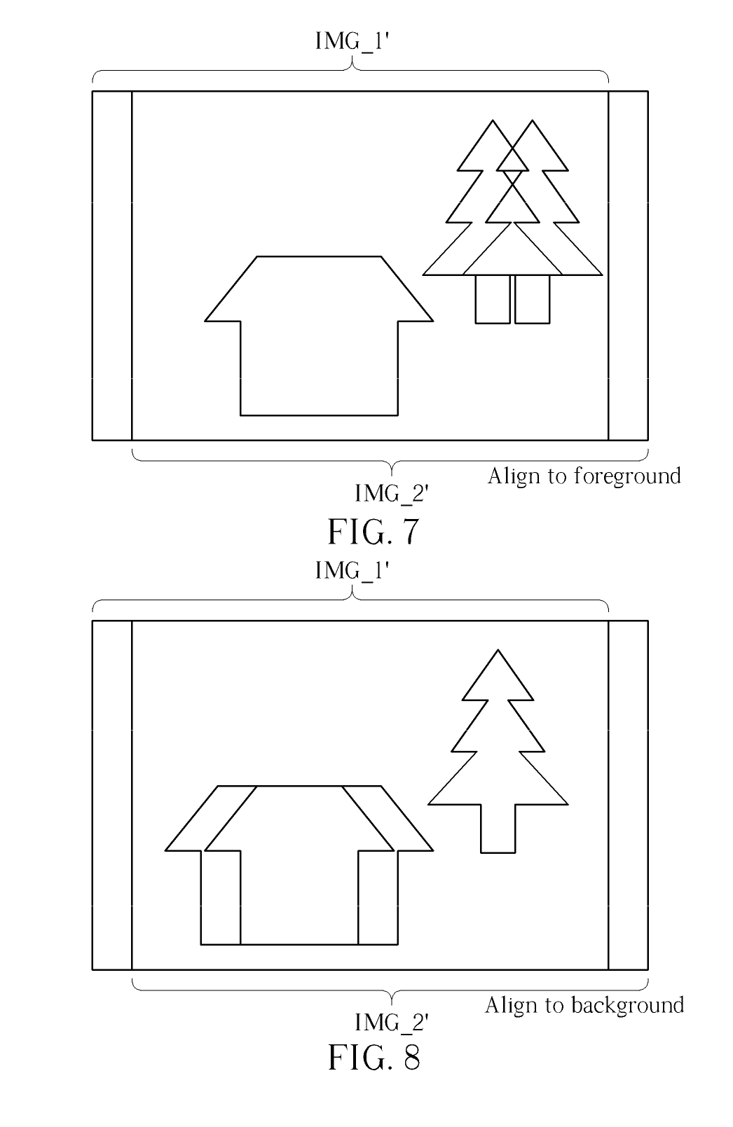

The image alignment unit 104 may operate in an automatic mode or a manual mode. In a case where the image alignment unit 104 is configured to operate in the automatic mode, the image alignment unit 104 is capable of automatically aligning the input images IMG_1 and IMG_2 without user intervention. That is, the image alignment unit 104 can start the image alignment operation upon receiving the input images IMG_1 and IMG_2. For example, the image alignment unit 104 may employ feature point extraction algorithm (e.g., corner detection algorithm) or block-based algorithm (e.g., sum of absolute difference (SAD) based algorithm) for aligning the input images IMG_1 and IMG_2 to generate the aligned images IMG_1′ and IMG_2′. When the image alignment unit 104 decides to align the foreground objects 502 in the input images IMG_1 and IMG_2, the resultant aligned images IMG_1′ and IMG_2′ are shown in FIG. 7. Alternatively, when the image alignment unit 104 decides to align the background objects 502 in the input images IMG_1 and IMG_2, the resultant aligned images IMG_1′ and IMG_2′ are shown in FIG. 8.

In another case where the image alignment unit 104 is configured to operate in the manual mode, the image alignment unit 104 is capable of aligning the input images IMG_1 and IMG_2 in response to a user input USER_IN which selects a region of interest (ROI). For example, one of the input images IMG_1 and IMG_2 may be displayed on a screen of the mobile device in which the image processing apparatus 100 is disposed, and the user may enter the user input USER_IN by performing the ROI selection according to the displayed input image IMG_1/IMG_2. When the user selects the displayed foreground object 502 as the ROI, the user input USER_IN may therefore instruct the image alignment unit 104 to align the foreground objects 502 in the input images IMG_1 and IMG_2 for obtaining the resultant aligned images IMG_1′ and IMG_2′ shown in FIG. 7. Alternatively, when the user selects the displayed background object 504 as the ROI, the user input USER_IN may therefore instruct the image alignment unit 104 to align the background objects 504 in the input images IMG_1 and IMG_2 for obtaining the resultant aligned images IMG_1′ and IMG_2′ shown in FIG. 8.

It should be noted that the above-mentioned image alignment operations are for illustrative purposes only, and are not meant to be limitations of the present invention. That is, as long as the desired aligned images can be obtained, the image alignment unit 104 is allowed to employ a different mage alignment algorithm for aligning the input images IMG_1 and IMG_2.

After the aligned images IMG_1′ and IMG_2′ are obtained successfully, the image alignment unit 104 can proceed with the operation of generating the image alignment related information INF by estimating the difference between at least portions of the aligned images IMG_1′ and MIG_2′. For example, if the input image IMG_1 is the selected image IMG_S to be processed by the defocus unit 106 of the image processing block 103, the image alignment unit 104 may treat the whole selected image IMG_S (i.e., IMG_1) as a block or divide the selected image IMG_S (i.e., IMG_1) into a plurality of blocks, and calculate an SAD value for each block according to the aligned images IMG_1′ and MIG_2′, where SAD values of the blocks can be provided to the defocus unit 106 as the image alignment related information INF. Alternatively, if the input image ING_2 is the selected image IMG_S (i.e., IMG_2) to be processed by the defocus unit 106, the image alignment unit 104 may treat the whole selected image IMG_S (i.e., IMG_2) as a block or divide the selected image IMG_S (e.g., IMG_2) into a plurality of blocks, and calculate an SAD value for each block according to the aligned images IMG_1′ and MIG_2′, where SAD values of the blocks can be provided to the defocus unit 106 as the image alignment related information INF.

The defocus unit 106 is capable of generating a processed image IMG_P by performing a defocus operation upon the selected image IMG_S (e.g., one of input images IMG_1 and IMG_2) according to the image alignment related information INF. For example, the defocus unit 106 may include a blur filter for applying a blur filtering operation to the whole selected image IMG_S to thereby generate the processed image IMG_P. In this exemplary embodiment, the image alignment related information INF is descriptive of a blur kernel, and the defocus unit 106 is capable of configuring the blur filter/blur filtering operation according to the image alignment related information INF. As mentioned above, the image alignment related information INF may include SAD values for blocks of the selected image IMG_S. Hence, the defocus unit 106 can refer to an SAD value of each block to control the blurriness of each block processed by the blur filter/blur filtering operation. In one exemplary design, the blurriness of the blur filtering operation applied to the selected image IMG_S by the defocus unit 106 can be proportional to the difference between at least portions of the aligned images IMG_1′ and IMG_2′. Therefore, when a block has a larger SAD value, the blur filter/blur filtering operation may make the block more blurred/defocused, and when a block has a smaller SAD value, the blur filter/blur filtering operation may make the block less blurred/defocused.

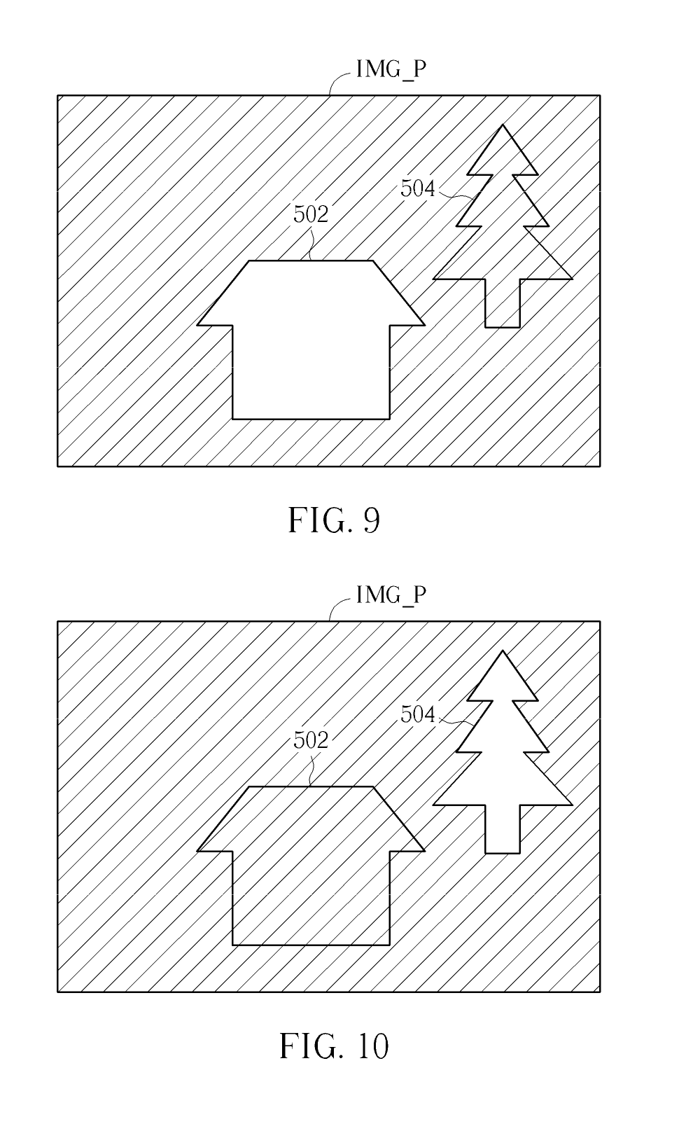

When the image alignment unit 104 aligns the foreground objects 502 in input images IMG_1 and IMG_2 as shown in FIG. 7, the SAD values for the foreground object 502 would be smaller due to higher similarity, while the SAD values for the background object 504 would be larger due to lower similarity. Thus, regarding the processed image IMG_P generated under such a condition, the foreground object 502 is clearer/more focused than the background object 504, as shown in FIG. 9. When the image alignment unit 104 aligns the background objects 504 in the input images IMG_1 and IMG_2 as shown in FIG. 8, the SAD values for the background object 504 would be smaller due to higher similarity, while the SAD values for the foreground object 502 would be larger due to lower similarity. Thus, regarding the processed image IMG_P generated under such a condition, the background object 504 is clearer/more focused that the foreground object 502, as shown in FIG. 10. In this way, the processed image IMG_P with shallow depth of field (e.g., an image with a focused foreground and a defocused background, or an image with a focused background and a defocused foreground) is efficiently created by the post-processing stage, including the image alignment operation and defocus operation.

After the processed image IMG_P is generated, the processed image IMG_P may be displayed on a screen of the mobile device in which the image processing apparatus 100 is disposed or any other device. Hence, the user would perceive shallow depth of field because one specific area of the processed image IMG_P is sharp/clear while other parts remain blurred. Besides, the mobile device may support other visual effects, such as image transition. For example, one of the input images IMG_1 and IMG_2, the processed image IMG_P, and the other of the input images IMG_1 and IMG_2 may be displayed sequentially.

FIG. 9 only shows one clearer/more focused object (i.e., the foreground object 502), and FIG. 10 only shows one clearer/more focused object (i.e., the background object 504). However, this is for illustrative purposes only, and is not meant to be a limitation of the present invention. In practice, there may be more than one aligned area/object with less blurriness applied thereto, and these aligned areas/objects are sharp/clear when displayed on the screen of the mobile device.

In above embodiment, the image processing block 103 has the image alignment unit 104 capable of providing the image alignment related information INF to the defocus unit 106. However, this is for illustrative purposes only, and is not meant to be a limitation of the present invention. That is, the image alignment unit 104 may be optional. The image processing block 103 is allowed to have a different configuration as long as the defocus visual effect is present in a processed image by using two or more input images with different image contents. For example, the spirit of the present invention is obeyed when the receiving unit 102 receives a plurality of input images that are sequentially captured through a single lens of an image capture device while the image capture device is moving and/or rotating, and the image processing block 103 generates a processed image by performing a defocus operation according to the input images. In addition, the spirit of the present invention is obeyed when the receiving unit 102 receives a plurality of input images that are respectively captured by multiple lens of one or more image capture devices, and the image processing block 103 generates a processed image by performing a defocus operation according to the input images.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing method, comprising:
receiving a plurality of input images;
deriving an image alignment related information from performing an image alignment upon the input images; and
generating a processed image by performing a defocus operation upon a selected image selected from the input images according to the image alignment related information.

2. The image processing method of claim 1, wherein the step of deriving the image alignment related information comprises:
aligning the input images to obtain aligned images; and
estimating difference between at least portions of the aligned images to generate the image alignment related information.

3. The image processing method of claim 2, wherein the input images are automatically aligned without user intervention.

4. The image processing method of claim 2, wherein the input images are aligned in response to a user input which selects a region of interest.

5. The image processing method of claim 1, wherein the step of generating the processed image comprises:
configuring a blur filtering operation according to the image alignment related information; and
applying the blur filtering operation to the selected image to generate the processed image.

6. The image processing method of claim 5, wherein the step of deriving the image alignment related information comprises:
aligning the input images to obtain aligned images; and
estimating difference between at least portions of the aligned images to generate the image alignment related information;
wherein blurriness of the blur filtering operation applied to the selected image is proportional to the difference between at least portions of the aligned images.

7. The image processing method of claim 1, wherein the step of receiving the input images comprises:
receiving the input images that are sequentially captured through a single lens of an image capture device while the image capture device is moving and/or rotating.

8. The image processing method of claim 1, wherein the step of receiving the input images comprises:
receiving the input images that are respectively captured by multiple lens of one or more image capture devices.

9. An image processing method, comprising:
receiving a plurality of input images that are sequentially captured through a single lens of an image capture device while the image capture device is moving and/or rotating; and
generating a processed image by performing a defocus operation according to the input images.

10. An image processing method, comprising:
receiving a plurality of input images that are respectively captured by multiple lens of one or more image capture devices; and
generating a processed image by performing a defocus operation according to the input images.

11. An image processing apparatus, comprising:
a receiving unit, capable of receiving a plurality of input images;
an image alignment unit, coupled to the receiving unit and capable of deriving an image alignment related information from performing an image alignment upon the input images; and
a defocus unit, coupled to the receiving unit and the image alignment unit, the defocus unit capable of generating a processed image by performing a defocus operation upon a selected image selected from the input images according to the image alignment related information.

12. The image processing apparatus of claim 11, wherein the image alignment unit is capable of aligning the input images to obtain aligned images, and estimating difference between at least portions of the aligned images to generate the image alignment related information.

13. The image processing apparatus of claim 12, wherein the image alignment unit is capable of automatically aligning the input images without user intervention.

14. The image processing apparatus of claim 12, wherein the image alignment unit is capable of aligning the input images in response to a user input which selects a region of interest.

15. The image processing apparatus of claim 11, wherein the defocus unit is capable of configuring a blur filtering operation according to the image alignment related information, and applying the blur filtering operation to the selected image to generate the processed image.

16. The image processing apparatus of claim 15, wherein the image alignment unit is capable of aligning the input images to obtain aligned images, and estimating difference between at least portions of the aligned images to generate the image alignment related information; and blurriness of the blur filtering operation applied to the selected image by the defocus unit is proportional to the difference between at least portions of the aligned images.

17. The image processing apparatus of claim 11, wherein the receiving unit is capable of receiving the input images that are sequentially captured through a single lens of an image capture device while the image capture device is moving and/or rotating.

18. The image processing apparatus of claim 11, wherein the receiving unit is capable of receiving the input images that are respectively captured by multiple lens of one or more image capture devices.

19. An image processing apparatus, comprising:
a receiving unit, capable of receiving a plurality of input images that are sequentially captured through a single lens of an image capture device while the image capture device is moving and/or rotating; and
an image processing block, capable of generating a processed image by performing a defocus operation according to the input images.

20. An image processing apparatus, comprising:
a receiving unit, capable of receiving a plurality of input images that are respectively captured by multiple lens of one or more image capture devices; and
an image processing block, capable of generating a processed image by performing a defocus operation according to the input images.
